(19) United States
(12) Patent Application Publication
(10) Pub. No.: US 2007/0207695 A1
(43) Pub. Date: Sep. 6, 2007

(54) IMAGE DISPLAY DEVICE AND METHOD OF MANUFACTURING THE DEVICE

(76) Inventors: Tsuyoshi Oyaizu, Hiratsuka-shi (JP); Yukio Okudo, Hiratsuka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/675,655

(22) Filed: Feb. 16, 2007

Related U.S. Application Data
(63) Continuation of application No. PCT/JP05/15763, filed on Aug. 30, 2005.

(30) Foreign Application Priority Data
Aug. 31, 2004 (JP) 2004-252700

(51) Int. Cl. H01J 9/00

(52) U.S. Cl. 445/24; 438/69; 445/41; 257/433

(57) ABSTRACT

An image display apparatus includes front panel, which further includes a plurality of phosphor layers formed on glass substrate, light absorbing layers provided between phosphor layers, respectively, electrically divided metal back layers formed on phosphor layers, getter dividing layers formed on light absorbing layers by depositing an insulator thereon, each as cliff-shaped deposit whose wall surfaces are angled by 90 to 80 degrees with respect to surface of the respective metal back layer, and getter layers stacked on the metal back layers and the getter dividing layers, respectively, the getter layer formed on the respective metal back layer and the getter layer formed on the respective getter dividing layer being electrically insulated from each other.

### CROSS-REFERENCE TO RELATED APPLICATIONS

This is a Continuation Application of PCT Application No. PCT/JP2005/015763, filed Aug. 30, 2005, which was published under PCT Article 21(2) in Japanese.

This application is based upon and claims the benefit of priority from prior Japanese Patent Application No. 2004-252700, filed Aug. 31, 2004, the entire contents of which are incorporated herein by reference.

### BACKGROUND OF THE INVENTION

1. Field of the Invention

The present invention relates to a flat-screen image display device such as field emission display (FED) and a method of manufacturing such a display.

2. Description of the Related Art

Recent years, the development of flat-screen image forming devices is being progressed. In such flat-screen image forming devices, it is necessary to electrically divide a metal back layer on a front substrate with a predetermined pattern in order to suppress discharge current when discharge occurs between the front substrate and rear substrate in the fluorescent surface structure. Further, it is of a general procedure to form a getter film on the metal back layer on the front substrate in order to maintain a high vacuum degree between the front substrate and rear substrate. However, here, since the getter film is electro-conductive, it is necessary to electrically divide it as in the above-mentioned case of the metal back layer.

Patent document 1 (Jpn. Pat. Appln. KOKAI Publication No. 2003-68237) discloses an image display apparatus and its manufacturing method, in which the division of the getter is carried out with a fine particle film formed on the metal back layer in order to electrically separate the electro-conductive getter layer into a plurality of layers. More specifically, according to this method, micro-particles whose particle diameter is controlled as desired are patterned on the metal back layer appropriately to form a film-like shape at a predetermined position, thereby dividing the getter film during a getter film formation which is a later step.

However, with the method of the conventional technique, the division property of the getter film is not stable, and therefore the productivity becomes accordingly low. Further, since the distance between divided getter film parts is very short, once discharge takes places, a chain of discharges will occur as currents go between divided getter film parts. As a result, discharge current cannot be controlled reliably, which is undesirable.

### BRIEF SUMMARY OF THE INVENTION

An object of the present invention is to provide an image display apparatus in which a plurality of getter films are insulated reliably from each other, to prevent large-scale discharge, thereby achieving an excellent operation stability, and a method of manufacturing such a display apparatus.

According to an aspect of the present invention, there is provided a n image display apparatus comprising a front panel and a rear panel set to face each other via a spacer therebetween, characterized in that the front panel comprises: a plurality of phosphor layers formed on a glass substrate; a plurality of light absorbing layers provided between the plurality of phosphor layers, respectively; electrically divided metal back layers formed on the plurality of phosphor layers; a plurality of getter dividing layers formed on the plurality of light absorbing layers by depositing an insulator thereon, each as a cliff-shaped deposit whose wall surfaces are angled by 90 to 80 degrees with respect to a surface of the respective metal back layer; and a plurality of getter layers stacked on the metal back layers and the getter dividing layers, respectively, the getter layer formed on the respective metal back layer and the getter layer formed on the respective getter dividing layer being electrically insulated from each other.

With the above-described structure of an image display apparatus according to an embodiment of the present invention, the wall surface of a getter dividing layer is formed to have such a cliff shape that the angle with respect to the getter dividing layer is 90 to 80 degrees, and thus a getter layer part formed on the getter dividing layer and another getter layer part fron on the metal back layer are formed sufficiently distant from each other.

Further, the thickness of the getter dividing layer is set to be sufficiently large, for example, in a range of 5 to 30 micrometers. Thus, as in the above-mentioned case, a getter layer part formed on the getter dividing layer and another getter layer part from on the metal back layer are formed sufficiently distant from each other and therefore the insulation between a plurality of getter layer parts can be reliably set up. In this manner, the getter layer can be electrically divided into a plurality of parts. Thus, a plurality of metal back layers can be electrically insulated from each other, thereby making it possible to reliably suppress abnormal discharge from a rear panel to a front panel. Therefore, it becomes possible to provide an image display apparatus with an excellent operation stability and such an image display apparatus can be mass-produced in a stable way.

### BRIEF DESCRIPTION OF THE SEVERAL VIEWS OF THE DRAWING

FIG. 1 is a cross section of an example of the front panel of an image display apparatus according to an embodiment of the present invention;

FIG. 2 is a cross section showing an enlarged view of an example of the getter dividing layer of the front panel of the image display apparatus according to the embodiment;

FIG. 3 is a cross section showing an enlarged view of an example of the getter dividing layer and getter layer of the front panel of the image display apparatus according to the embodiment;

FIG. 4 is an explanatory diagram showing a step of forming a getter dividing layer of the front panel of the image display apparatus according to the embodiment;

FIG. 5 is a cross section showing an example of the structure of the image display apparatus according to the embodiment; and

FIG. 6 is a diagram showing an example of discharge characteristics of the image display apparatus according to the embodiment.

### DETAILED DESCRIPTION OF THE INVENTION

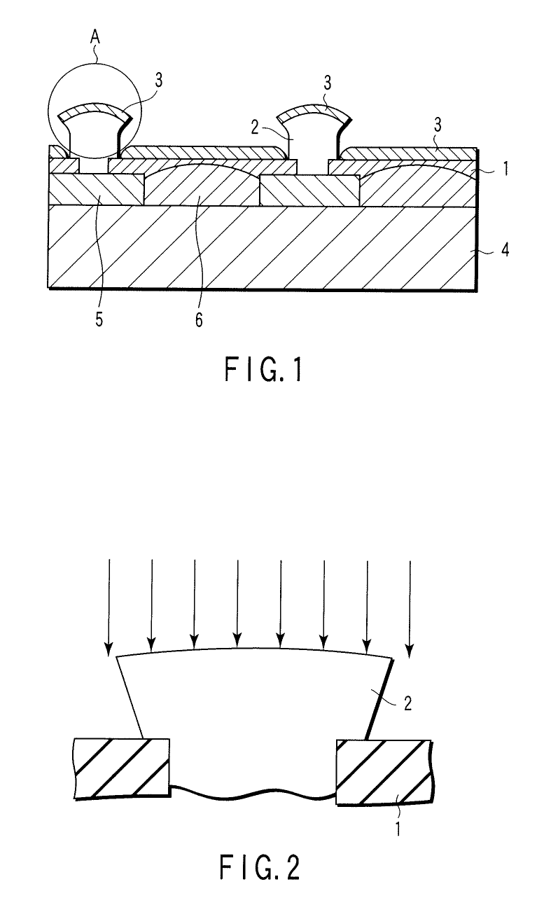

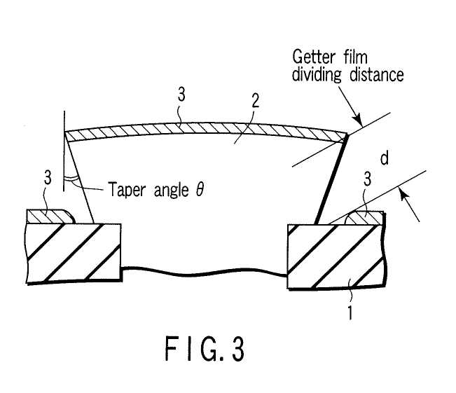

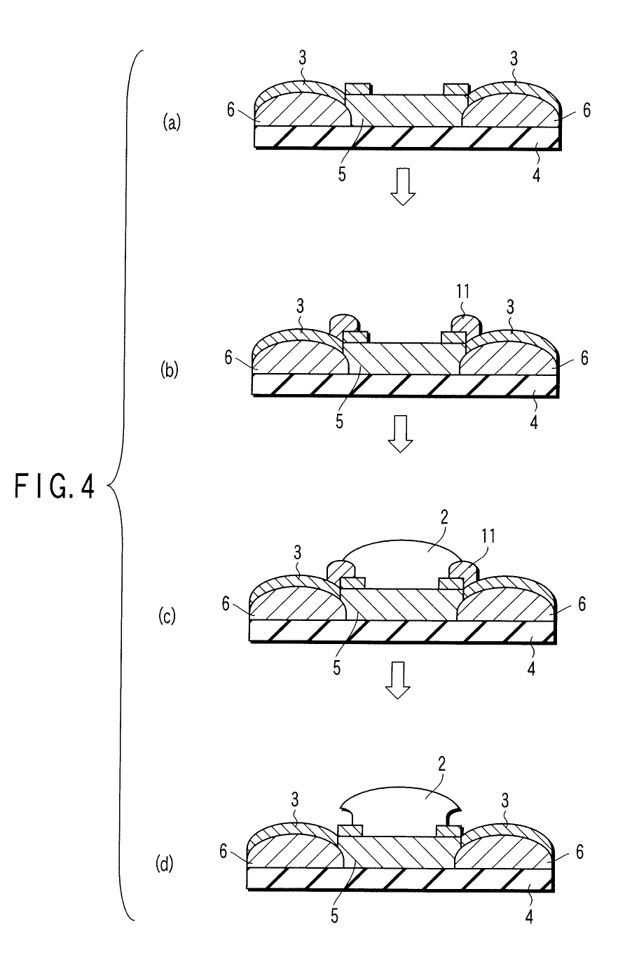

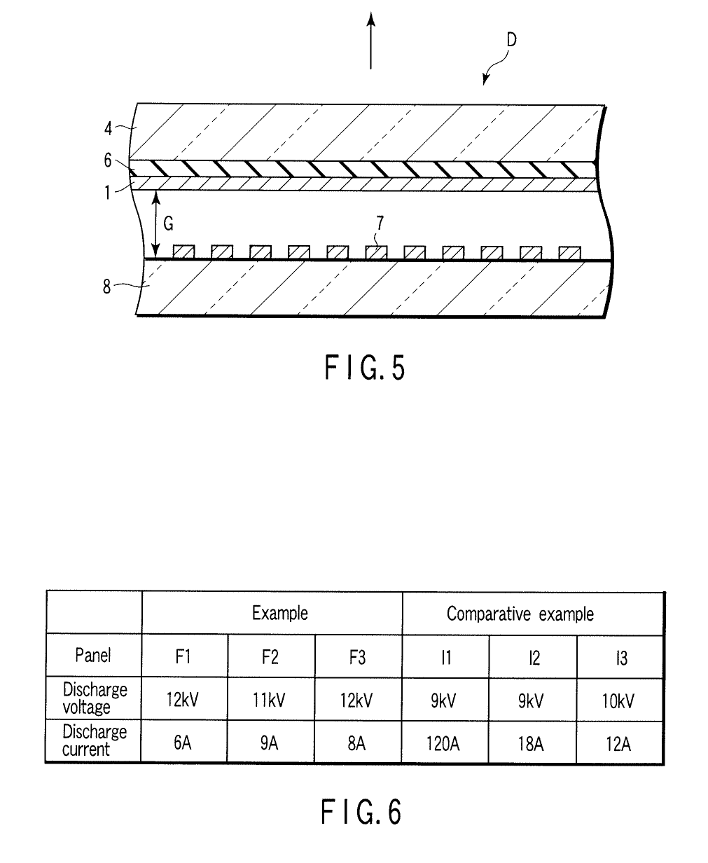

An embodiment of the display apparatus of the present invention will now be described in detail with reference accompanying drawings. FIG. 1 is a cross section of an example of the front panel of an image display apparatus according to an embodiment of the present invention. FIG. 2 is a cross section showing an enlarged view of an example of the getter dividing layer of the front panel of the image display apparatus according to the embodiment. FIG. 3 is a cross section showing an enlarged view of an example of the getter dividing layer and getter layer of the front panel of the image display apparatus according to the embodiment. FIG. 4 is an explanatory diagram showing a step of forming a getter dividing layer of the front panel of the image display apparatus according to the embodiment. FIG. 5 is a cross section showing an example of the structure of the image display apparatus according to the embodiment. FIG. 6 is a diagram showing an example of discharge characteristics of the image display apparatus according to the embodiment.

<Image Display Apparatus According to an Embodiment of the Present Invention>

(Structure)

An embodiment of the display apparatus of the present invention will now be described in detail with reference accompanying drawings. As shown in FIG. 5, an image display apparatus D according to the embodiment includes a glass substrate 4 of a front panel and a glass substrate 8 of a rear panel, which is provided to face the glass substrate 4 of the front panel. Thus, the front panel includes at least the glass substrate 4, phosphor layer 6 that forms images by the irradiation of electron beams emitted from an electron source and the metal back layer 1, which is a metal layer. The glass substrate 4 of the front panel and the glass substrate 8 of the rear panel are set to face each other with a narrow gap G of about 1 to several millimeters therebetween, and with this structure, a high voltage of 5 to 15 kV is applied to the gap G of such an extremely narrow distance between the glass substrate 4 of the front panel and the glass substrate 8 of the rear panel. Further, a great number of electron releasing elements 7 arranged in matrix are provided on the glass substrate 8 of the rear panel.

Here, according to the embodiment of the present invention, a metal back layer 1 is provided on the glass substrate 4 of the front panel of the image display apparatus D. Although it is not clearly illustrated in FIG. 1, a portion of the metal back layer 1, in which a getter dividing layer 2 is formed, is electrically isolated from others. That is, as shown in FIG. 1 as an example, a plurality of light absorbing layers (black matrix layers) 5 are provided with grooves, by which these layers are electrically insulated from each other.

Alternatively, it is possible to electrically divide it into a plurality of layers insulated from each other by transforming an aluminum layer into aluminum oxide. In this manner, even if discharge once occurs in a metal back layer, a chain of discharges can be avoided. Similarly, the getter layer 3 may be separated into a plurality of electrically isolated regions as measures to discharge. In order to electrically divide the getter layer 3 located above into stripe patterns reliably insulated from each other, an insulator is deposited in the grooves formed between the metal back layers and on the plurality of light absorbing layers. In this manner, a plurality of getter dividing layers 2 are provided, which are cliff-shaped deposits whose wall surfaces are angled in a range of 90 to 80 degrees with respect to the surface of the respective metal back layers.

That is, in the image display apparatus D according to the embodiment, as shown in FIG. 5 using (a) on FIG. 4 of the present invention, the front panel of the elements 4, 6 and 1 and the rear panel 8 are formed via a spacer, and a space between the front panel including the elements 4, 6 and 1 and the rear panel 8 is evacuated to a high vacuum degree as shown in FIG. 5. Thus, the front panel of the image display apparatus that displays images by radiating electron beams from the electron source 7 provided on the rear panel onto phosphors provided in the front panel to emit light is manufactured. The formation step of a getter dividing layer 2 of the front panel of the image display apparatus according to the embodiment is explained in FIG. 4.

As shown in (a) on FIG. 4, first, a plurality of phosphor layers 6 are formed on a glass substrate 4 and a plurality of light absorbing layers 5 are formed between the phosphor layers, respectively. Further, a metal back layer 1 is formed on the phosphor layers and light absorbing layers, and portions of the metal back layer that are located on the light absorbing layers are removed to form grooves. Thus, the metal back layer is divided into portions.

After that, as shown in (b) on FIG. 4, for example, materials 11 are formed on the light absorbing layers and near the respective grooves of the metal back layers. Then, as shown in (c) on FIG. 4, the getter dividing layers are patterned such as to cover a part of the material 11, and then the layers are baked. After that, as shown in (d) on FIG. 4, the materials 11 are removed, and thus the remaining getter dividing layer 2 is shaped to have a cliff-like predetermined tapered angle θ as shown in FIG. 4.

Here, the materials 11 may be of a type that can be removed with a specialized tool such as tweezers or a knife, or a type that can be removed as it is burned down by heat. Or it may be of a type that can be removed by melting with an appropriate chemical solvent. Further, it may be of a type that can be removed by making it easily separatable chemically and then removing it with, for example, wind pressure. It should be noted that in each case, the type that is suitable for its respective removing method should be prepared for the materials 11.

Here, if the taper angle is 0 degree or more (the angle between the wall surface and the metal back is 90 degrees), the deposited getter film pouring from the upper section of the getter dividing layer 2 cannot be divided. On the other hand, when it is 80 degrees or less, it is not possible to form the getter dividing layers 2 in a stable manner. Further, when the thickness of the getter dividing layers is 5 micrometers or less, the distance between the divided getter films becomes excessively short, thereby generating a chain of discharges. On the other hand, when it is 30 micrometers, the getter dividing layer itself serves as a discharge source. For these reasons, the thickness of the getter dividing layers 2 must fall in a range of 5 to 30 micrometers.

Examples of the getter dividing layers 2 are filler agents such as SiO2, TiO2, MnO, ATO, ITO, Al2O3 and Fe2O3, but the invention is not limited to these. It is alternatively possible that a glass agent is added to enhance the strength of the film.

Here, a method of manufacturing an image display apparatus according to an embodiment of the present invention will now be described in more detail by way of an example.

First, the phosphor layer 6 was patterned at a predetermined position on the glass substrate 4 of the front panel, and further an Al layer was formed thereon. This Al layer was a metal back layer 1 divided by a predetermined pattern on the phosphor layer 6. The phosphor layer 6 was formed by a conventional method such as a screen printing method, and the pattering of the Al layer 1 could be formed by a conventional method such as a mask deposition. Then, the getter dividing layer 2 was formed by the screen printing method on the Al dividing pattern formed on the glass substrate 4 by the manufacture process shown in FIG. 4. That is, a resin layer was formed by the screen printing method using a composition B, and after that, the getter dividing layer 2 was formed by the screen printing method using a composition C. Further, the resultant was baked at a temperature of 450° C. to erase the resin layer, thus obtaining the getter dividing layer 2.

It should be noted that the definitions of the compositions were:

| | | | |
|---|---|---|---|
| Composition B | Ethyl cellulose | 8 | wt % |
| | Butylcarbitol acetate | 92 | wt % |
| Composition C | Fe2O3 (1 nm) | 15 | wt % |
| | Frit glass | 20 | wt % |
| | Ethyl cellulose | 8 | wt % |
| | Butylcarbitol acetate | 59 | wt % |

The getter-dividing-layer attached glass substrate 4 thus obtained and the electron source attached glass substrate 8 were adhered together with a spacer therebetween. Then, the inner section between these substrates was evacuated to a vacuum and further the getter layer 3 was deposited to the glass substrate 4 within a vacuum container. Thus, a high vacuum image display apparatus D (F2) was manufactured. Further, with the same method, F2 and F3 were prepared. A voltage was applied to these panels F1 to F3, and thus the discharge voltage and discharge current were measured as characteristics of discharge occurring between the glass substrate 4 and 8. The results obtained were summarized in FIG. 6.

### COMPARATIVE EXAMPLE USING COMPOSITION G

Further, the getter dividing layer 2 that uses a composition G, which will be defined below, were formed on the Al dividing pattern formed on the glass substrate 4, thus forming the getter-dividing-layer attached glass substrate 4. After that, an image display panel I1 was obtained by a similar method to that of the above-described example.

The composition G are defined as:

| | | | |
|---|---|---|---|
| Composition G | SiO2 (1.5 μm) | 20 | wt % |
| | Frit glass | 15 | wt % |
| | Ethyl cellulose | 6 | wt % |
| | Butylcarbitol acetate | 59 | wt % |

Further, with this method, image display panels I2 and I3 were prepared. A voltage was applied to the image display panels I1 to I3, and thus the discharge voltage and discharge current were measured as characteristics of discharge occurring between the glass substrate 4 and the glass substrate 8. The results obtained were summarized as those of comparative example in FIG. 6. As can be understood from FIG. 6, the panel of the example is superior to that of the comparative example in both of the discharge voltage and discharge current and further the panel of the example is more stable in terms of variation.

As described above, in the image display apparatus of the example of the present invention, the getter dividing layer is formed to have such a cliff-like shape that the taper angle to the metal back layer is in a range of 0 to 80 (the angle between the wall surface and the metal back is 90 degrees). With this structure, the getter film formed on the getter dividing layer and the getter film formed on metal back layer are set apart from each other sufficiently. Therefore, a chain of discharges can be prevented and thus it becomes possible to provide an image display apparatus with an excellent operation stability and a method of manufacturing such an apparatus.

With the above-described various examples, it is possible for a person having ordinary skill in the art to realize the present invention. Further, it is easy for a person having ordinary skill in the art to conceive various modifications of the example or to apply the present invention to various embodiments without an inventive ability. Thus, the scope of the present invention is so wide as long as a version does not contradict to the disclosed principle or novel features, and therefore the present invention, naturally, is not limited to the examples described above.

What is claimed is:

1. An image display apparatus comprising a front panel and a rear panel set to face each other via a spacer therebetween, wherein the front panel comprises:
a plurality of phosphor layers formed on a glass substrate;
a plurality of light absorbing layers provided between the plurality of phosphor layers, respectively;
electrically divided metal back layers formed on the plurality of phosphor layers;
a plurality of getter dividing layers formed on the plurality of light absorbing layers by depositing an insulator thereon, each as a cliff-shaped deposit whose wall surfaces are angled by 90 to 80 degrees with respect to a surface of the respective metal back layer; and
a plurality of getter layers stacked on the metal back layers and the getter dividing layers, respectively, the getter layer formed on the respective metal back layer and the getter layer formed on the respective getter dividing layer being electrically insulated from each other.

2. The image display apparatus according to claim 1, wherein a thickness of the getter dividing layers is in a range of 5 micrometers to 30 micrometers.

3. A method of manufacturing an image display apparatus in which a front panel and a rear panel are set to face each other via a spacer therebetween, and a space between the front panel and rear panel is evacuated to a high vacuum, which displays an image by radiating electron beam from an electron source provided in the front panel to make a phosphor provided in the front panel to emit light, the method comprising:
forming a plurality of phosphor layers formed on a glass substrate;
forming a plurality of light absorbing layers provided between the plurality of phosphor layers, respectively;
forming a metal back layer on the plurality of phosphor layers and electrically dividing the metal back layer into a plurality of metal back layers;
depositing an insulator on the plurality of light absorbing layers, thereby forming a plurality of getter dividing layers each as a cliff-shaped deposit whose wall surfaces are angled by 90 to 80 degrees with respect to a surface of the respective metal back layer; and
forming a plurality of getter layers stacking on the metal back layers and the getter dividing layers, respectively, the getter layer formed on the respective metal back layer and the getter layer formed on the respective getter dividing layer being electrically insulated from each other.

4. The manufacturing method according to claim 3, wherein a thickness of the getter dividing layers is in a range of 5 micrometers to 30 micrometers.

5. The manufacturing method according to claim 3, wherein a taper angle of each getter dividing layer is realized by providing a predetermined layer on both sides of a place where the getter dividing layer is to be formed before the formation of the respective getter dividing film, and then evaporating the predetermined layers.
